(19) United States
(12) Patent Application Publication
(10) Pub. No.: US 2016/0173234 A1
(43) Pub. Date: Jun. 16, 2016

(54) BASE STATION APPARATUS, TERMINAL DEVICE, AND TRANSMISSION METHOD

(71) Applicant: SHARP KABUSHIKI KAISHA, Osaka (JP)

(72) Inventors: Ryota YAMADA, Osaka-shi (JP); Kozue YOKOMAKURA, Osaka-shi (JP); Katsuya KATO, Osaka-shi (JP); Hiromichi TOMEBA, Osaka-shi (JP)

(73) Assignee: Sharp Kabushiki Kaisha, Osaka (JP)

(21) Appl. No.: 14/905,566

(22) PCT Filed: Jul. 10, 2014
(86) PCT No.: PCT/JP2014/068480

§ 371 Date: Jan. 15, 2016

(30) Foreign Application Priority Data
Jul. 23, 2013 (JP) 2013-152610

(51) Int. Cl. H04L 1/00

(52) U.S. Cl. CPC H04L 1/0075; H04L 1/0045

(57) ABSTRACT

Provided are a base station apparatus, a terminal device, and a transmission method which allow detection of a desired signal at high accuracy irrespective of whether an interference signal is an initially transmitted signal or a retransmitted signal. The base station apparatus notifies the terminal device of terminal information which is information about an interfering terminal device, and includes a terminal information generation unit that generates terminal information, and the terminal information generation unit therein generates the terminal information that varies depending on redundancy versions of an interference signal, and, even in a case where the interference signal has been transmitted by using a redundancy version with the large number of parity bits, the terminal device is able to perform appropriate suppression and cancellation of the interference, thus making it possible to improve throughput.

### TECHNICAL FIELD

The present invention relates to a base station apparatus, a terminal device, and a transmission method.

### BACKGROUND ART

In recent years, as smartphones and tablet terminals have been used widely, traffic in mobile communication has been increasing exponentially and is expected to increase further in the future. As one of countermeasures against such an increase in wireless traffic, dense deployment of base stations in a heterogeneous network has been studied. The dense deployment of base stations is carried out aiming at decreasing a load of a macro base station by deploying low power base stations (LPN: Low Power Node) and the like in a macro cell and connecting a terminal device to a low power base station. At this time, inter-cell interference becomes a problem.

In order to improve cell throughput, MU-MIMO (Multi-User Multiple Input Multiple Output) in which a plurality of terminal devices are spatially multiplexed has been also studied. In the MU-MIMO, interference between terminal devices (inter-user interference) becomes a problem.

To cope with such inter-cell interference and inter-user interference, in a 3GPP (3rd Generation Partnership Project), NAICS (Network Assisted Interference Cancellation and Suppression) in which a terminal device suppresses or cancels an interference signal has been studied. In NAICS, the terminal device receives information about an interfering terminal device and detects a signal addressed to the interfering terminal device for performing interference cancellation. NAICS is described in NPL 1.

### CITATION LIST

### Non Patent Literature

NPL 1: RP-130404, “Study on Network-Assisted Interference Cancellation and Suppression for LTE,” 3GPP TSG RAN Meeting #59, March 2013.

### SUMMARY OF INVENTION

### Technical Problem

In many wireless communication systems, a hybrid automatic repeat request (HARQ) is performed. The HARQ is a technique by which, when an error is detected in a received data signal, retransmission is requested and an initially transmitted signal which has been held and a retransmitted signal which is received are combined to thereby perform error correction efficiently. IR (Incremental Redundancy) is one of HARQ schemes. With the IR, a data signal is subjected to error correction coding with a certain coding rate, and bits are removed therefrom (subjected to puncturing) so as to achieve a desired coding rate, and an initial transmission signal is transmitted. Subsequently, a signal including a bit sequence subjected to the puncturing at the time of the generation of the initial transmission signal is transmitted as a retransmission signal. The terminal device combines the initially transmitted signal which has been held and the retransmitted signal which is received. At this time, error correction performance is improved because the coding rate is lowered.

However, since an interference signal is detected and cancelled in NAICS, when only the retransmitted signal is multiplexed as an interference signal, there is no initial transmission signal of the interference signal and error correction accuracy of the interference signal deteriorates considerably, so that the interference cancellation performance is lowered.

The invention has been made in view of such circumstance and an object thereof is to provide a base station apparatus, a terminal device, and a transmission method which allow detection of a desired signal at high accuracy irrespective of whether an interference signal is an initially transmitted signal or a retransmitted signal.

### Solution to Problem

In order to solve the aforementioned problems, a base station apparatus, a terminal device, and a transmission method according to the invention are configured as follows.

A base station apparatus of the invention is a base station apparatus that notifies a terminal device of terminal information which is information about an interfering terminal device, including: a terminal information generation unit that generates terminal information, in which the terminal information generation unit generates the terminal information that varies depending on redundancy versions of an interference signal.

Moreover, in the base station apparatus of the invention, the terminal information generation unit generates terminal information that allows suppression and cancellation of interference on a code word level in a case where a redundancy version, among the redundancy versions, includes a largest number of systematic bits.

Moreover, in the base station apparatus of the invention, the terminal information generation unit generates terminal information that allows suppression and cancellation of interference on a symbol level other than a case where a redundancy version, among the redundancy versions, includes a largest number of systematic bits.

Moreover, a terminal device of the invention includes a signal detection unit that performs suppression and cancellation of interference depending on redundancy versions included in terminal information about an interfering terminal device, which is notified by a base station apparatus, and that performs detection of information data.

Moreover, in the terminal device of the invention, the signal detection unit performs suppression and cancellation of interference on a code word level in a case where a redundancy version, among the redundancy versions, includes a largest number of systematic bits.

Moreover, in the terminal device of the invention, a scheme of the suppression and cancellation of interference is turbo interference cancellation.

Moreover, in the terminal device of the invention, the signal detection unit performs suppression and cancellation of interference on a symbol level other than a case where a redundancy version, among the redundancy versions, includes a largest number of systematic bits.

Moreover, in the terminal device of the invention, a scheme of the suppression and cancellation of interference is maximum likelihood detection.

Moreover, a transmission method of the invention is a transmission method used by a base station apparatus that notifies a terminal device of terminal information about an interfering terminal device, including: a terminal information generation step of generating the terminal information, in which at the terminal information generation step, the terminal information that varies depending on a redundancy version is generated.

### Advantageous Effects of Invention

According to the invention, provided is a base station apparatus that notifies a terminal device of terminal information about an interfering terminal device, including a terminal information generation unit that generates terminal information, in which the terminal information generation unit generates the terminal information that varies depending on redundancy versions of an interference signal. Thus, even in a case where the interference signal has been transmitted by using a redundancy version with the large number of parity bits, the terminal device is able to perform appropriate suppression and cancellation of interference, thus making it possible to improve throughput.

### BRIEF DESCRIPTION OF DRAWINGS

FIG. 1 is a schematic view of a communication system according to a first embodiment.

FIG. 2 is a schematic block diagram of a base station apparatus according to the first embodiment.

FIG. 3 is a schematic block diagram of a coding unit according to the first embodiment.

FIG. 4 is an explanatory view of a bit selection unit according to the first embodiment.

FIG. 5 is a flowchart of processing in the base station apparatus according to the first embodiment.

FIG. 6 is a schematic block diagram of a terminal device according to a second embodiment.

FIG. 7 is a flowchart of processing in the terminal device according to the second embodiment.

### DESCRIPTION OF EMBODIMENTS

### First Embodiment

A first embodiment of the invention will be described below. A communication system of the present embodiment includes a base station (a transmission apparatus, a cell, a transmission point, a transmission antenna group, a transmit antenna port group, a component carrier, eNodeB) and a terminal (a terminal device, a mobile terminal, a reception point, a reception terminal, a reception device, a receive antenna group, a receive antenna port group, UE).

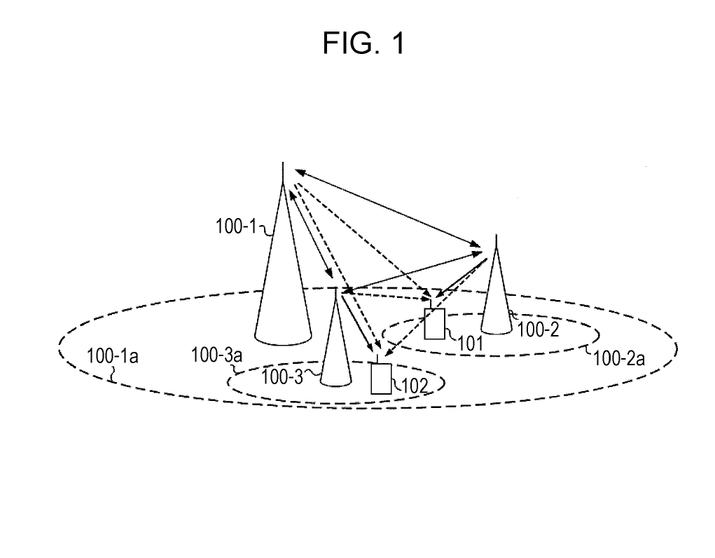

FIG. 1 is a view illustrating one example of the communication system according to the first embodiment. In FIG. 1, a base station apparatus (also referred to as a macro base station or a first base station) 100-1, base station apparatuses having lower transmit power than that of the macro base station (also referred to as LPNs: Low Power Nodes, lower power base stations, or second base stations) 100-2 and 100-3, and terminal devices 101 and 102 are provided. 100-1a denotes coverage of the macro base station 100-1 (macro cell), and 100-2a and 100-3a respectively denote coverage of the low power base stations 100-2 and 100-3 (pico cell, small cell etc.) The coverage is a range in which the base station apparatus is able to be connected to the terminal devices (communication area). Although the following describes an example in which the macro base station and the low power base station form a multi cell, the invention is not limited thereto, and the macro base station alone may form a multi cell or the low power base station alone may form a multi cell. Though a case where the macro base station is connected to the terminal device is not illustrated, the case where the macro base station is connected to the terminal device is also included in the invention. Further, the base station apparatuses may be connected to one another in a wireless manner or by cable.

When there are a plurality of low power base stations, the low power base stations may have different transmit powers from one another. The macro base station and the low power base station may be distinguished by transmit power, and also, the discrimination may be performed between a base station having backward compatibility that supports a scheme which has already launched and a base station having no backward compatibility, which is newly defined.

Schemes that provide service (versions of a communication system, options, etc.) may be different between the low power base stations.

In the invention, the number of cells, the number of base stations, the number of terminal devices, types of cells (for example, a macro cell, a pico cell, a femto cell, a small cell, etc.), and types of base stations are not limited to the embodiment below. The small cells are completely overlapped with the macro cell in FIG. 1, but may be partially overlapped or may not be overlapped therewith.

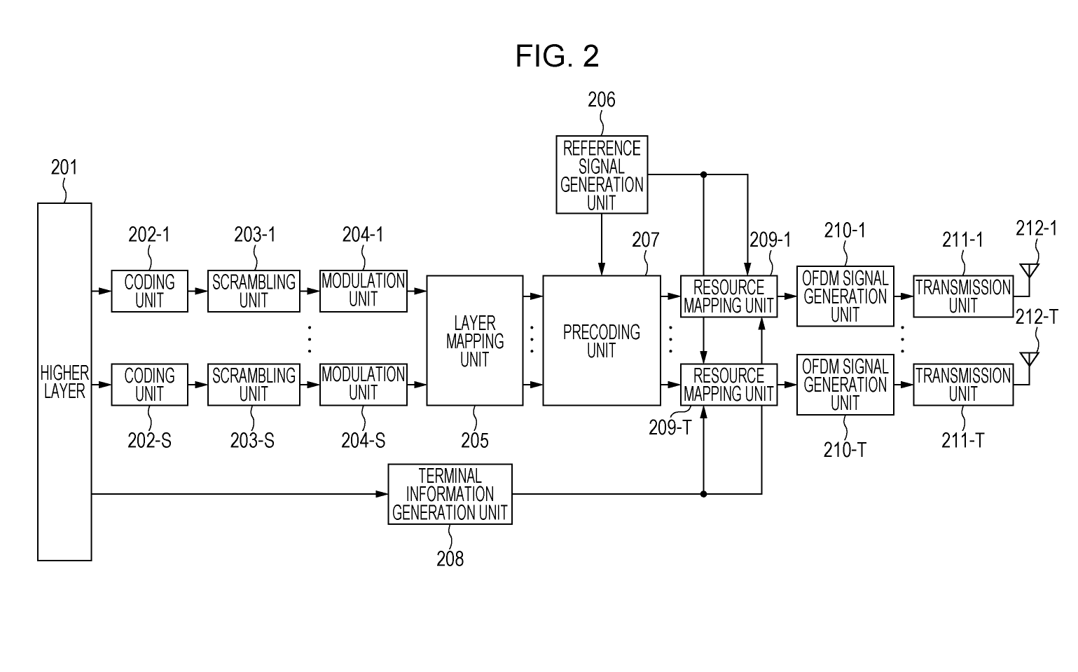

FIG. 2 is a schematic block diagram illustrating a configuration of the base station apparatus according to the present embodiment. The base station apparatus includes a higher layer 201, coding units 202-1 to 202-S, scrambling units 203-1 to 203-S, modulation units 204-1 to 204-S, a layer mapping unit 205, a reference signal generation unit 206, a precoding unit 207, a terminal information generation unit 208, resource mapping 209-1 to 209-T, OFDM signal generation units 210-1 to 210-T, transmission units 211-1 to 211-T, and transmit antennas 212-1 to 212-T. In the figure, S denotes the number of spatially multiplexed streams. T denotes the number of transmit antennas. Note that, when a part or all of the aforementioned base station apparatus is integrated into an integrated circuit chip, a chip control circuit that controls functional blocks is provided.

The higher layer 201 is a layer of a function higher than a physical layer among layers of a communication function defined by an OSI reference model, for example, a MAC (Media Access Control) layer, a data link layer, a network layer and the like. Moreover, the higher layer 201 also notifies parts constituting the base station apparatus of other parameters needed for exerting the functions of the parts.

The coding units 202-1 to 202-S perform error correction coding for information data received from the higher layer 201, and after performing rate matching (puncturing), generate coded bits (also referred to as code words). Rate matching processing is performed in order to match a coding rate of a data sequence subjected to the error correction coding with a coding rate corresponding to a data transmission rate. The information data is, for example, an audio signal for a phone call, a still image or a moving image signal representing a photographed image, a character message, or the like. A coding scheme used by the coding units 202-1 to 202-S to perform error correction coding is, for example, turbo coding, convolutional coding, low density parity check coding (LDPC), or the like.

The scrambling units 203-1 to 203-S scramble code words received from the coding units 202-1 to 202-S based on respective cell IDs.

The scrambled code words are mapped into modulation symbols in the modulation units 204-1 to 204-S. The modulation processing that the modulation units 204-1 to 204-S perform is, for example, BPSK (Binary Phase Shift keying), QPSK (Quadrature Phase Shift Keying), M-QAM (M-Quadrature Amplitude Modulation, for example, M=16, 64, 256, 1024, and 4096), or the like. Note that, the modulation units 204-1 to 204-S may have a function to sort and interleave the generated modulation symbols.

The modulation symbols are subjected to layer mapping for spatial multiplex in the layer mapping unit 205. For example, LTE-A (LTE-Advanced) supports up to eight layers and one code word is subjected to mapping to up to four layers.

The reference signal generation unit 206 generates reference signals, and outputs a reference signal for which precoding needs to be performed to the precoding unit 207, and outputs a reference signal for which precoding is not to be performed to the resource mapping units 209-1 to 209-T.

The precoding unit 207 performs precoding for the output of the layer mapping unit 205. Note that, the same precoding as that of a data signal to be demodulated may be performed for a part of the reference signals, for example, a DMRS (DeModulation Reference Symbol).

The terminal information generation unit 208 generates information of another terminal device (also referred to as terminal information) in order that the terminal device detects and cancels an interference signal. The terminal information is information supporting demodulation and decoding of a signal transmitted to another terminal device, such as, a cell ID, a modulation scheme, a coding rate, a reference signal, an antenna port number, resource allocation information, and a Redundancy Version (RV) of HARQ (Hybrid Auto Repeat reQuest). The terminal information may serve as a control signal.

The resource mapping units 209-1 to 209-T map an output of the precoding unit 207, reference signals, and the terminal information into resources.

Outputs of the resource mapping units 209-1 to 209-T are transmitted from the transmit antennas 212-1 to 212-T after being subjected to IFFT (Inverse Fast Fourier Transform), insertion of Cyclic Prefix (CP) in the OFDM (Orthogonal Frequency Division Multiplexing) signal generation units 210-1 to 210-T, and digital/analog transform, filtering, frequency transform, and the like in the transmission units 211-1 to 211-T.

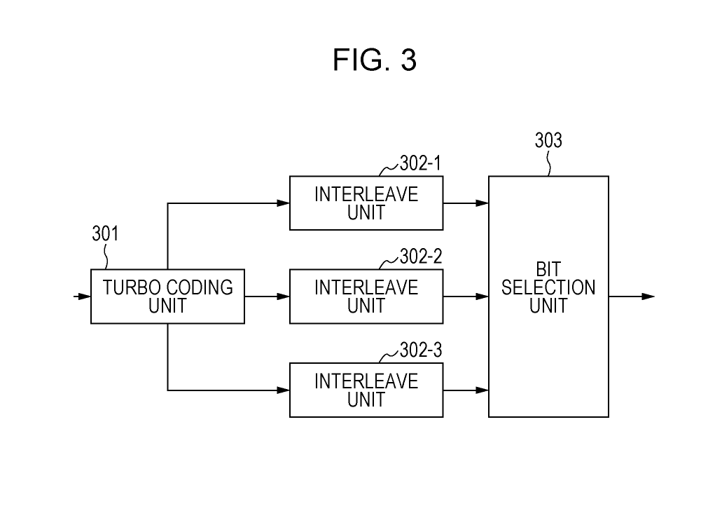

FIG. 3 is a schematic block diagram illustrating one example of a configuration of one coding unit of the coding units 202-1 to 202-S. Here, a case where error correction coding is performed by turbo coding will be described. The coding unit includes a turbo coding unit 301, interleave units 302-1 to 302-3, and a bit selection unit 303. The turbo coding unit 301 performs coding with a certain coding rate. Here, a case where coding is performed with a coding rate of ⅓ will be described. In this case, the turbo coding unit 301 outputs three sequences of a systematic bit sequence, a first parity bit sequence, and a second parity bit sequence. The interleave units 302-1 to 302-3 are sub-block interleavers for interleaving the systematic bit sequence, the first parity bit sequence, and the second parity bit sequence, respectively. The interleave units 302-1 to 302-3 are three blocks in order to perform parallel processing, but one interleave unit may be merely required in a case where serial processing is performed. The bit selection unit 303 performs puncturing of the bit sequences so as to achieve a rate which is determined by the RV, rate matching or the like, and outputs the bit sequences to be transmitted. Note that, the coded bit sequences are held until the terminal device is able to receive information data correctly. The coded bit sequences which are held are able to be used for the HARQ.

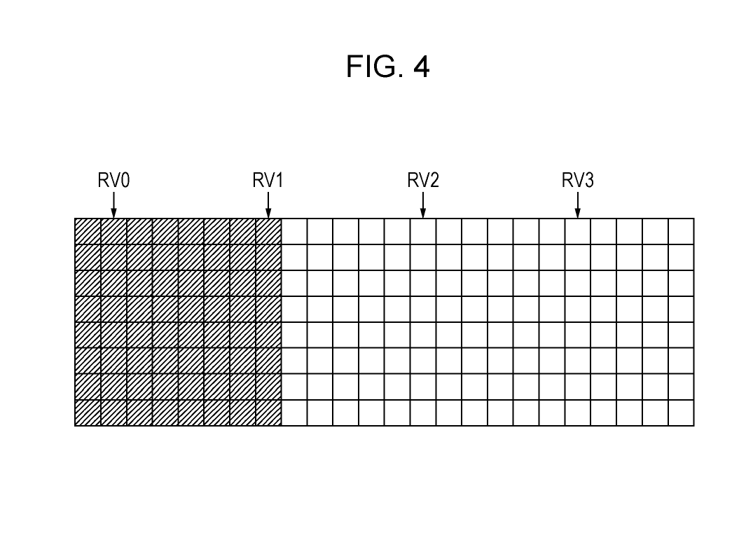

FIG. 4 is a view for explaining processing in the bit selection unit 303. FIG. 4 represents a two-dimensional circular buffer. Coded bits after interleaving are arranged in squares of the figure. The systematic bit sequence is arranged in shaded areas and the first parity bit sequence and the second parity bit sequence are arranged alternately in a longitudinal direction in white areas. The required number of bits is read in the longitudinal direction from the arranged bit sequences with the RV as a start position. Note that, the LTE (Long Term Evolution) has four kinds of RVs. Here, the four kinds of RVs are represented as RV0 to RV3. Note that, RV0 to RV3 represent cases where values of the RV are 0, 1, 2 and 3, respectively. Moreover, RV0 includes the largest number of systematic bits among the RVs. In a case of initial transmission, RV0 is normally used. In a case of retransmission, any of RV0 to RV3 is used. Note that, the RV to be used may be determined according to the number of times of retransmission.

The base station apparatus in the present embodiment notifies the terminal device of terminal information about an interfering terminal device. When an interference signal is a retransmitted signal, the terminal device has not necessarily received or held an initially transmitted signal of the interfering terminal device. At this time, when the interference signal is a retransmitted signal and the number of systematic bits is small (for example, RV1, RV2, or RV3), performance of error correction decoding considerably deteriorates. Accordingly, when the interference signal is RV1 to 3, the terminal device is desired to perform an interference suppression and cancellation scheme which does not involve error correction decoding.

Thus, the terminal information generation unit 208 generates terminal information which varies depending on the RV. In a case of the RV with the large number of systematic bits, for example, RV0, terminal information which allows performing an interference suppression and cancellation scheme on a code word level (also referred to as first terminal information) is generated. The interference suppression and cancellation scheme on a code word level is a reception scheme which involves error correction decoding, and examples thereof include a Turbo SIC (Successive Interference Canceller), a Turbo PIC (Parallel Interference Canceller), MAP (Maximum A posteriori Probability) detection, and the like. In a case of the RV with the large number of parity bits, for example, RV1 to RV3, terminal information which allows an interference suppression and cancellation scheme on a symbol level (also referred to as second terminal information) is generated. Examples of the interference suppression and cancellation scheme on a symbol level include linear detection of a symbol level SIC, a symbol level PIC, MLD (Maximum Likelihood Detection), MLD with a small amount of operations, MMSE (Minimum Mean Square Error) detection, and the like.

Note that, the terminal information generation unit 208 is also able to cause information indicating an interference suppression scheme performed by the terminal device to be included in the terminal information.

Note that, the terminal information of the interfering terminal device is notified by another base station apparatus, and, at this time, the terminal information may vary or may not vary depending on the RV. The similar is also applied to a case where the terminal information is notified to the other base station apparatus.

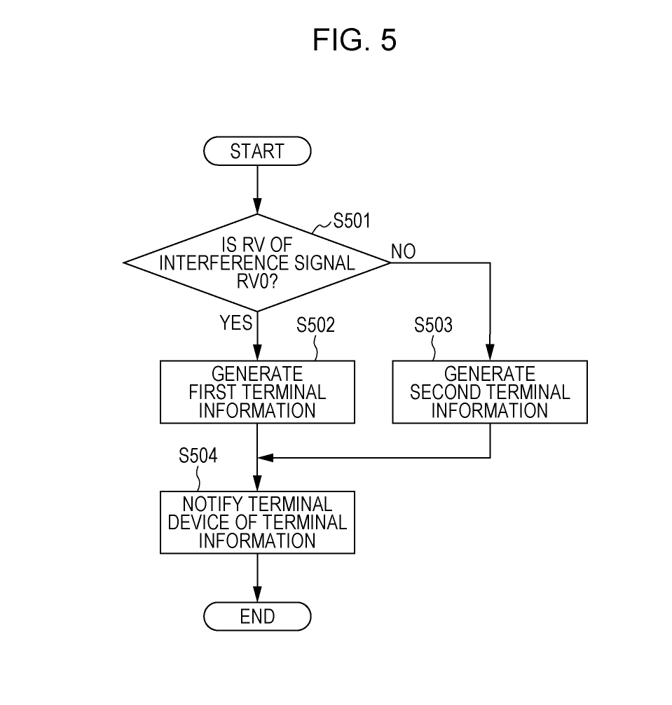

FIG. 5 is a flowchart illustrating processing in the base station apparatus in the present embodiment. The terminal information generation unit 208 judges whether the RV of an interfering terminal device which is notified by another base station apparatus is RV0 (step S501), and in a case of RV0, generates first terminal information (step S502), and in a case of RV1 to RV3, generates second terminal information (step S503). The base station apparatus notifies the terminal device of the generated terminal information at step S504.

In this manner, terminal information which varies depending on the RV is notified to the terminal device in the present embodiment. Thus, even in a case where the interference signal has been transmitted by using the RV with the large number of parity bits, the terminal device is able to perform appropriate interference suppression and cancellation, thus making it possible to improve throughput.

Note that, the base station apparatus is also able to change an MCS (Modulation and Coding Scheme) of the terminal device, which is to be connected, depending on the RV of the interference signal.

### Second Embodiment

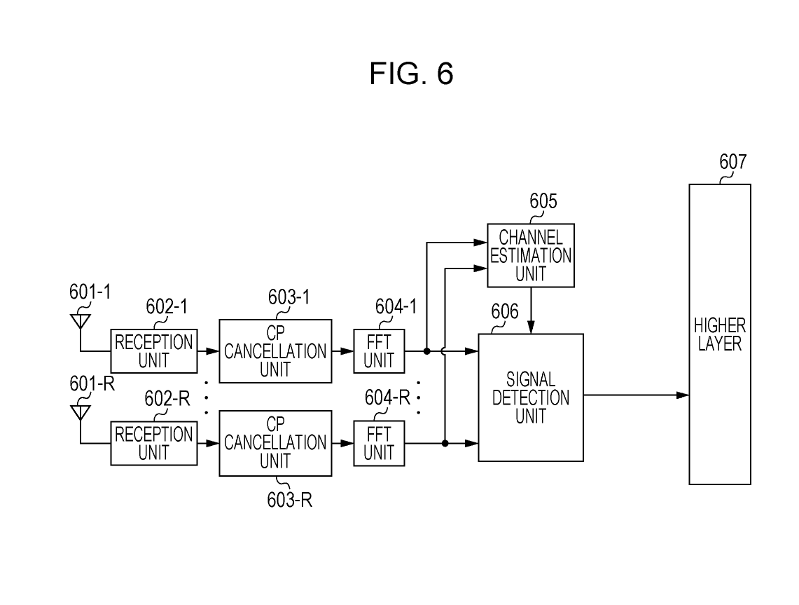

FIG. 6 is a schematic block diagram illustrating a configuration of the terminal device in the present embodiment. The terminal device includes receive antennas 601-1 to 601-R, reception units 602-1 to 602-R, CP cancellation units 603-1 to 603-R, FFT units 604-1 to 604-R, a channel estimation unit 605, a signal detection unit 606, and a higher layer 607. When a part or all of the terminal device is integrated into an integrated circuit chip, a chip control circuit (not illustrated) that controls the functional blocks is provided. Note that, R denotes the number of the receive antennas.

The terminal device receives signals by the receive antennas 601-1 to 601-R and performs frequency transform, filtering, analog/digital transform, and the like at the reception units 602-1 to 602-R. Outputs of the reception units 602-1 to 602-R are subjected to cancellation of cyclic prefix at the CP cancellation units 603-1 to 603-R, and time-frequency transform at the FFT units 604-1 to 604-R. The channel estimation unit 605 obtains a channel estimation value by using a DMRS. When the DMRS has been subjected to precoding, the channel estimation value including precoding is obtained. The signal detection unit 606 cancels the interference signal with which terminal information is notified by the base station apparatus, obtains information data transmitted to the terminal device, and outputs the information data to the higher layer 607.

The signal detection unit 606 uses a different scheme of suppression and cancellation of interference according to terminal information notified by the base station apparatus. The signal detection unit 606, in a case where the RV included in the terminal information is RV0, performs interference suppression and cancellation using a code word-level scheme (also referred to as first interference cancellation), and in a case of RV1 to RV3, performs interference suppression and cancellation using a symbol-level scheme (also referred to as second interference cancellation).

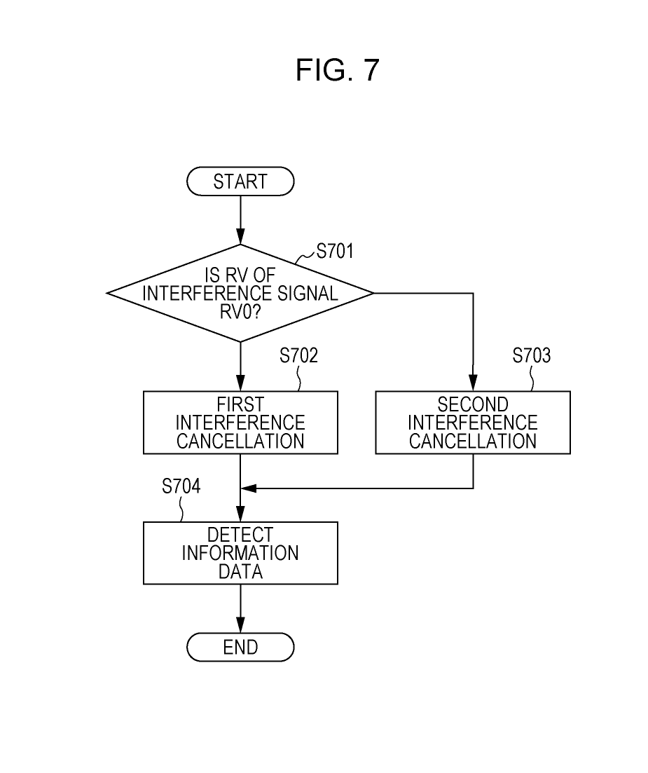

FIG. 7 is a flowchart of processing in the terminal device in the present embodiment. The signal detection unit 606 judges whether the RV included in the terminal information notified by the base station apparatus is 0 (step S701), and in a case of RV0, performs the first interference cancellation (step S702), and in a case of RV1 to RV3, performs the second interference cancellation (step S703), and obtains information data to end processing (step S704).

In this manner, suppression and cancellation of the interference is differently performed according to the redundancy version of the interference signal notified by the base station apparatus. This makes it possible to perform interference suppression and cancellation appropriate to the interference signal, thus making it possible to improve throughput.

Note that, the interference signal may be also held in the terminal device irrespective of the redundancy version and subjected to HARQ combining.

Note that, the terminal device feeds back a CQI (Channel Quality Indicator) to the base station apparatus in the LTE, and when the RV of the interference signal is known, for example, by notification by the base station apparatus, the CQI is able to be obtained by assuming an interference suppression and cancellation scheme which varies depending on the RV.

When the RV is not known, the CQI after the first interference cancellation may be fed back, the CQI after the second interference cancellation may be fed back, or the CQI when it is regarded that there is no interference may be fed back.

Note that, a program which is operated in the base station apparatus and a mobile station device according to the invention is a program which controls a CPU and the like (program that causes a computer to function) so as to realize functions of the aforementioned embodiments related to the invention. In addition, information which is handled by the apparatus and devices is temporarily accumulated in a RAM at the time of processing therein, and then stored in various ROMs or an HDD, and is read, modified, and written by the CPU as necessary. A recording medium that stores the program may be any of a semiconductor medium (for example, a ROM, a nonvolatile memory card or the like), an optical recording medium (for example, a DVD, an MO, an MD, a CD, a BD or the like) and a magnetic recording medium (for example, a magnetic tape, a flexible disc or the like). Moreover, by executing the loaded program, not only the functions of the embodiments described above are realized, but also by performing processing in cooperation with an operating system, other application programs or the like based on an instruction of the program, the functions of the invention are realized in some cases.

When being distributed in the market, the program is able to be stored in a portable recording medium and distributed or transferred to a server computer connected through a network such as the Internet. In this case, a storage device of the server computer is also included in the invention. A part or all of the mobile station device and the base station apparatus in the embodiments described above may be realized as an LSI which is a typical integrated circuit. Functional blocks in a reception device may be individually integrated into a chip, or a part or all thereof may be integrated into a chip. When any of the functional blocks is made into an integrated circuit, an integrated circuit control unit for controlling them is added.

Further, a method for making into an integrated circuit is not limited to the LSI and a dedicated circuit or a versatile processor may be used for realization. Further, in a case where a technique for making into an integrated circuit in place of the LSI appears with advance of a semiconductor technique, an integrated circuit by the technique is also able to be used.

Note that, the invention of the present application is not limited to the embodiments described above. The terminal device of the invention of the present application is not limited to be applied to the mobile station device, and, needless to say, is applicable to stationary or unmovable electronic equipment which is installed indoors or outdoors such as, for example, AV equipment, kitchen equipment, a cleaning/washing machine, air conditioning equipment, office equipment, an automatic vending machine, other domestic equipment, and the like.

As above, the embodiments of the invention have been described in detail with reference to drawings, but specific configurations are not limited to the embodiments, and a design and the like which are not departed from the main subject of the invention are also included in a scope of claims.

### INDUSTRIAL APPLICABILITY

The invention is suitably used for a base station apparatus, a terminal device, and a transmission method. Note that, the international patent application claims priority based on Japanese Patent Application No. 2013-152610 filed on Jul. 23, 2013, and the entire contents of Japanese Patent Application No. 2013-152610 are hereby incorporated by reference.

### REFERENCE SIGNS LIST

100-1, 100-2, 100-3 base station apparatus

101, 102 terminal device

201, 607 higher layer

202-1 to 202-S coding unit

203-1 to 203-S scrambling unit

204-1 to 204-S modulation unit

205 layer mapping unit

206 reference signal generation unit

207 precoding unit

208 terminal information generation unit

209-1 to 209-T resource mapping unit

210-1 to 210-T OFDM signal generation unit

211-1 to 211-T transmission unit

212-1 to 212-T transmit antenna

301 turbo coding unit

302-1 to 302-3 interleave unit

303 bit selection unit

601-1 to 601-R receive antenna

602-1 to 602-R reception unit

603-1 to 603-R CP cancellation unit

604-1 to 604-R FFT unit

605 channel estimation unit

606 signal detection unit

1-9. (canceled)

10. A base station apparatus that communicates with a terminal device, comprising:
a terminal information generation unit that generates terminal information used for cancelling an interference signal; and
a transmission unit that transmits the terminal information to the terminal device, wherein
the terminal information generation unit generates the terminal information assumed reception processing of which varies depending on redundancy versions of the interference signal.

11. The base station apparatus according to claim 10, wherein the terminal information generation unit generates terminal information for decoding the interference signal in a case where a redundancy version, among the redundancy versions, includes a largest number of systematic bits.

12. The base station apparatus according to claim 10, wherein the terminal information generation unit generates terminal information for demodulating the interference signal other than a case where a redundancy version, among the redundancy versions, includes a largest number of systematic bits.

13. A terminal device that communicates with a base station apparatus, comprising:
a reception unit that receives terminal information used for cancelling an interference signal; and
a signal detection unit that performs cancellation of interference with a scheme which varies depending on redundancy versions included in the terminal information.

14. The terminal device according to claim 13, wherein the signal detection unit performs cancellation of interference on a code word level in a case where a redundancy version, among the redundancy versions, includes a largest number of systematic bits.

15. The terminal device according to claim 14, wherein a scheme of the cancellation of interference is iterative interference cancellation.

16. The terminal device according to claim 13, wherein the signal detection unit performs cancellation of interference on a symbol level other than a case where a redundancy version, among the redundancy versions, includes a largest number of systematic bits.

17. The terminal device according to claim 16, wherein a scheme of the cancellation of interference is maximum likelihood detection.

18. A communication method used by a terminal device that communicates with a base station apparatus, comprising:
a reception step of receiving terminal information used for cancelling an interference signal; and
a signal detection step of performing cancellation of interference with a scheme which varies depending on redundancy versions included in the terminal information.
